(19) United States
(12) Patent Application Publication
(10) Pub. No.: US 2024/0412896 A1
(43) Pub. Date: Dec. 12, 2024

(54) Co-axial interconnect for low temperature applications

(71) Applicant: Leiden Cryogenics B.V., Leiden (NL)

(72) Inventors: Giorgio FROSSATI, LEIDEN (NL); Arjette DE WAARD, LEIDEN (NL); Oleksander USENKO, LEIDEN (NL)

(21) Appl. No.: 18/695,300

(22) PCT Filed: Sep. 23, 2022
(86) PCT No.: PCT/NL2022/050537

§ 371 Date: Mar. 25, 2024

(30) Foreign Application Priority Data
Sep. 24, 2021 (NL) 2029241

(51) Int. Cl. H01B 7/42; H01B 7/02; H01B 13/00

(52) U.S. Cl. CPC H01B 7/421; H01B 7/02; H01B 13/0036

(57) ABSTRACT

Disclosed is an electrical interconnect for use at cryogenic temperatures, wherein the electrical interconnect has an inner electrical conductor, an electrically insulating layer that substantially surrounds the inner electrical conductor, an outer electrical conductor substantially co-axial with the inner electrical conductor, and a heat transfer element, wherein the heat transfer element has an electrically insulating material, wherein the heat transfer element has a thermal conductivity which is larger than a thermal conductivity of the electrically insulating layer, and wherein the heat transfer element is arranged in an opening in the insulating layer and is configured for thermally connecting the inner electrical conductor with the outer electrical conductor.

### BACKGROUND

The invention relates to an electrical interconnect for use in low temperature application, in particular for use at cryogenic temperatures. Furthermore, the invention relates to a cooling system for cooling an electrical interconnect. Furthermore, the invention relates to a method for manufacturing an electrical interconnect for use in low temperature applications. Furthermore, the invention relates to a method for cooling the inner electrical conductor of an electrical interconnect.

For devices that operate at cryogenic temperatures, in particular at temperatures in the milli-Kelvin range or close to absolute zero, it is usually essential that the cooled device continuously remains at said low temperature during operation. For example, in the case of quantum computing devices even a relatively small increase in temperature may result in thermal vibrations that cause a loss of quantum coherence.

Generally, such systems use electrical interconnects such as coaxial cables and/or connectors for transmitting signals between the various components of the device. Coaxial cables typically consist of an inner conductor surrounded by a concentric outer conductor, wherein the two conductors are separated by a dielectric insulating layer that surrounds the inner conductor.

The use of the electrical interconnect however provides a pathway for the transport of heat into and between the attached components of the device. In addition, the electrical interconnect itself can also introduce undesired heat, particular in case the electrical interconnect is not adequately cooled to said very low temperatures. As a result, it is essential that the electrical interconnect itself also is cooled down and remains at said very low temperature.

GB 1,156,428, for example, discloses the use of coaxial tubes, comprising an inner conductor tube which is surrounded by a conductive co-axial tube of the same material, wherein a of electrical insulation layer separates the inner and outer tubes. The coaxial tubes are arranged inside an outer wall frame which is surrounded by thermal insulation. In use, liquid hydrogen is pumped through the center section of the coaxial tubes, thus keeping the inter conductor tube cold, and is returned over the outside of the coaxial tubes through a space between the coaxial tubes and the outer wall frame. Accordingly, both the inner conductor tube and the surrounding conductive co-axial tube are cooled by said liquid hydrogen.

### SUMMARY OF THE INVENTION

A disadvantage of the known coaxial electrical interconnects for use at cryogenic temperatures is that cooling of an inner conductor by using a tube shaped inner conductor and pumping liquid hydrogen through said tube shaped inner conductor requires an complex system for handling the cryogenic liquid, for example for injecting said cryogenic liquid in the tube shape inner conductor on one side of the coaxial electrical interconnect and for directing the cryogenic liquid from the center section of the inner conducting to the outer section of the co-axial outer conductor. In addition, the coaxial tubes arranged in an outer wall frame as described in GB 1,156,428 provide a substantially bulky and relatively rigid electrical interconnect. It is noted that without the tube shaped inner conductor, the cooling of the inner conductor is hindered by the thermally insulating nature of the electrical insulating layer which surrounds the inner electrical conductor.

It is an object of the present invention to provide an alternative electrical interconnect that permits cooling of the inner conductor of the electrical interconnect.

According to a first aspect, the invention provides an electrical interconnect for use at cryogenic temperatures, wherein the electrical interconnect comprises:
an inner electrical conductor,
an electrically insulating layer that substantially surrounds the inner electrical conductor,
an outer electrical conductor substantially co-axial with the inner electrical conductor, and
a heat transfer element,
wherein the heat transfer element comprises an electrically insulating material, wherein the heat transfer element comprises a thermal conductivity which is larger than a thermal conductivity of the electrically insulating layer, wherein the heat transfer element is arranged in an opening in the insulating layer and is configured for thermally connecting the inner electrical conductor with the outer electrical conductor,
wherein the electrical interconnect preferably comprises a thermal interface material, wherein the thermal interface material is located between the heat transfer element and the inner electrical conductor.

It is noted that for the proper operation of a co-axial electrical interconnect, it is essential that the layer of material between the inner electrical conductor and the co-axial outer electrical conductor is electrically insulating. It is further noted that electrically insulating materials commonly have a very low thermal conductivity.

De inventor has used the fact that some electrically insulating materials have a relatively high thermal conductivity, and which is used to provide a heat transfer element according to the invention. Examples of such materials are diamond, graphite, silicon and sapphire. The addition of the heat transfer element in the coaxial electrical interconnect provides a local thermal bridge between the outer electrical conductor and the inner electrical conductor.

In addition, the inventor has used the fact that electrically conducting materials, such as the inner and the outer electrical conductor, commonly have a high thermal conductivity. Due to the relatively high thermal conductivity along the inner electrical conductor and along the outer electrical conductor a local thermal bridge is substantially sufficient for cooling a substantial length of the inner electrical conductor of the coaxial electrical interconnect. As a result, the heat transfer element allows cooling of the inner electrical conductor, effectively bypassing the thermally insulating effects of the insulating layer that separates the two electrical conductors.

Furthermore, due to the significantly more accessible arrangement of the outer electrical conductor compared to the inner electrical conductor, the process of cooling the electrical interconnect by applying a heatsink or a cooling medium to the outer electrical conductor, provides a more simplified way of cooling the inner electrical conductor via the outer electrical conductor and the heat transfer element. At the same time, due to the electrically insulating nature of the heat transfer element, the transmission characteristics of the electrical interconnect are substantially unaffected.

In an embodiment, the heat transfer element has a cylindrical shape, preferably a circle-cylindrical shape. The use of a cylindrically shaped heat transfer element allows for more convenient production of the heat transfer element, as the heat transfer element may be produced by for example a hollow-cored drill. Furthermore, the cylindrical-shape allows for a convenient manufacturing of a corresponding opening in the electrically insulating layer and/or the outer electrical conductor that the heat transfer element passes through, for example via drilling.

In an embodiment, a center of the line cylindrically shaped heat transfer element is oriented substantially perpendicularly to a longitudinal axis of the inner electrical conductor. The perpendicular orientation of the center line of the heat transfer element provides for a minimal distance between the inner electrical conductor and the outer electrical conductor, and thus for a minimal length along the center line of the heat transfer element. This decreases the thermal resistance against heat transfer between the inner electrical conductor and the outer electrical conductor via the heat transfer element. Furthermore, such a perpendicular orientation simplifies the process of disposing the heat transfer element in the electrical interconnect.

In an embodiment, the thermal interface material is also located between the heat transfer element and the outer electrical conductor. The placement of the thermal interface material at the interfaces between the heat transfer element and the inner and/or outer electrical conductors respectively, enhances a thermal contact between these elements. Furthermore, the addition of the thermal interface material allows for smoothing out of any geometric defects that may be present on the surfaces of the heat transfer element and the inner and outer electrical conductors, which would otherwise disturb to the heat transfer between these elements.

It is noted that because the thermal interface material is preferably arranged only between the thermal transfer element and the inner electrical conductor and between the thermal transfer element and the outer electrical conductors, respectively, the thermal interface material may be electrically conductive, as no direct electrically conductive path exists between the inner and outer electrical conductors. As a result, a significantly wider range of materials can be used as the thermal interface material.

In an embodiment, the thermal interface material is a thermally conductive adhesive, preferably wherein the thermal interface material is a metal-filled epoxy, most preferably wherein the thermal interface material is a silver-filled epoxy. The use of an adhesive allows for more convenient assembly/production of the electrical interconnect, and ensures that the heat transfer element remains fixedly in place during both transport and use. Furthermore, the use of the metal-filled, or more preferably silver-filled, epoxy allows for a combination of a strong bonding adhesive while allowing for sufficient thermal conductivity of the thermal interface material.

In an embodiment, the amount of metal/silver in said metal-filled epoxy is larger than 70%, preferably larger than 80%. In an embodiment, the silver-filled epoxy comprises 70-95% of silver powder, preferably 90-95% of silver powder. Preferably the above mentioned silver content refers to a volume percentage. Such a large percentage of metal/silver provides a suitable thermal conductivity in combination with adequate adhesive properties to properly retain the heat transfer element.

In an embodiment, the heat transfer element extends a first distance along a direction substantially perpendicular to a longitudinal axis of the inner electrical conductor, wherein the first distance is greater than or substantially equal to a thickness of the insulating layer. By providing a heat transfer element that extends over a length substantially equal to the thickness of the insulating layer, the heat transfer element substantially bridges the distance between the inner conductor and the outer conductor, which enhances the heat transfer and/or reduces the amount of thermal interface material required to provide an adequate heat transfer between the inner conductor and the outer conductor.

In an embodiment, the first distance is smaller than or substantially equal to a sum of the thickness of the insulating layer and a of thickness the outer electrical conductor. Accordingly, the heat transfer element can be arranged to be mounted substantially within the circumference of the outer conductor, providing a substantially smooth outer surface f the electrical interconnect.

In an embodiment, the heat transfer element is fabricated from an aluminum oxide based material, preferably wherein the heat transfer element is fabricated a single crystal sapphire material. The use of from aluminum oxide based materials, and especially single crystal sapphire-based materials, provides a highly beneficial combination of a low electrical conductivity and a high thermal conductivity.

Preferably, the single crystal sapphire material is oriented such that a crystal axis of the single crystal sapphire material with the highest thermal conductivity is oriented perpendicularly to the longitudinal axis of the inner electrical conductor. In particular, the transfer element is configured such that the C-axis direction of the single crystal material sapphire is oriented substantially perpendicular to the longitudinal axis of the inner electrical conductor. This embodiment is advantageous because the thermal conductivity along the C-axis direction of the single crystal sapphire material is approximately 10% higher than in a direction perpendicular to this C-axis direction.

In an embodiment, the outer electrical conductor substantially coaxially surrounds the electrically insulating layer, preferably wherein the electrically insulating layer is configured to substantially fill the space between the inner electrical conductor and the outer electrical conductor.

In an embodiment, the outer electrical conductor comprises CuNi or stainless steel, and/or wherein the inner electrical conductor comprises CuNi or silver plated the isolating layer comprises CuNi, and/or wherein polytetrafluoroethylene (PFTE). The use of a CuNi, or cupronickel, is beneficial due to its combination of good ductility retention, a high electrical and a high thermal conductivity at low temperatures.

In an embodiment, the electrical interconnect comprises an opening, wherein the opening extends between the inner electrical conductor and at least the outer electrical layer, wherein the heat transfer element is arranged in said opening, and wherein the opening is configured such that the physical dimensions of the opening are substantially equal to the physical dimensions of the heat transfer element. Accordingly, a good mechanical fit is provided between the opening and the heat transfer element, which promotes the mechanical stability of the heat transfer element within the opening. Furthermore a good mechanical fit between the heat transfer element and the opening ensures that the heat transfer element substantially closes off the opening.

In an embodiment, wherein the electrical interconnect comprises a heat transfer surface, wherein said heat transfer surface comprises a part of the outer electrical conductor, the heat transfer element and/or the thermal interface material, wherein said heat transfer surface is configured to be thermally connectable with a heatsink or a cooling medium. Providing the outer electrical conductor and/or the heat transfer element, or the thermal interface material arranged to connect the heat transfer element to the outer electrical conductor, with a heat transfer surface allows a user to connect the electrical interconnect, through said heat transfer surface, with a suitable heatsink of cooling medium. This in turn allows for the extraction of thermal energy from the inner electrical conductor, via the heat transfer element and/or the outer electrical conductor, to the heatsink or cooling medium. Preferably, the heatsink or cooling medium is actively cooled to temperatures in the milli Kelvin (mK) range, which in turn allows the inner electrical conductor to also be kept at said temperatures.

In an embodiment, the electrical interconnect is a coax cable, or a SMA, SMP, MCX or MMCX type connector.

In an embodiment, the electrical interconnect comprises two or more heat transfer elements.

In an embodiment, the two or more heat transfer elements are arranged along a circumference of the electrical interconnect, preferably in a plane substantially perpendicular to a longitudinal direction of the electrical interconnect. By arranging two or more heat transfer elements in parallel along the circumference of the electrical interconnect, the heat transfer between the inner electrical conductor and the outer electrical conductor can be enhanced.

In an embodiment, the two or more heat transfer elements are arranged spaced apart, preferably in a direction along a longitudinal axis of the electrical interconnect. By arranging two or more heat transfer elements in parallel along the longitudinal axis of the electrical interconnect, also longer electrical interconnecting cables can be effectively cooled.

According to a second aspect, the invention for cooling an electrical provides a cooling system interconnect comprising the electrical interconnect according to the first aspect of the invention, or an embodiment thereof, and a cryocooler,
wherein the cryocooler comprises a heatsink, wherein the cryocooler is configured for actively cooling said heatsink,
wherein the heatsink is configured to be placed in thermal contact with the outer electrical conductor of the electrical interconnect,
preferably wherein the cryocooler is configured for actively cooling said heatsink to temperatures below 1 K, more preferably temperatures below 100 mK, most preferably below 10 mK.

According to a third aspect, the invention provides a method for manufacturing an electrical interconnect according to the first aspect of the invention, or an embodiment thereof, wherein the method comprises the steps of:
providing an electrical interconnect which comprises an inner electrical conductor, an electrically insulating layer that substantially surrounds the inner electrical conductor, an outer electrical conductor substantially co-axial with the inner electrical conductor, and an opening, wherein the opening extends through the insulating layer, and wherein the opening extends from the outer electrical conductor to at least the inner electrical conductor,
disposing a heat transfer element in the opening and thermally connecting the heat transfer element with the inner electrical conductor and with the outer electrical conductor in order to thermally bridge the conductor with the inner electrical outer electrical conductor of the electrical interconnect, wherein the heat transfer element comprises an electrically insulating material, wherein the heat transfer element comprises a thermal conductivity which is larger than a thermal conductivity of the electrically insulating layer.

In an embodiment, the method further comprises the step of:
applying a first thermal interface material between the inner electrical conductor and the heat transfer element, wherein the step of applying a first thermal interface material is performed before the step of disposing the heat transfer element within the opening.

In an embodiment, the first thermal interface material is a thermally conductive adhesive, preferably wherein the first thermal interface material is a metal-filled epoxy, most preferably wherein first thermal interface material is a silver-filled epoxy.

In an embodiment, the method further comprises the step of:
applying a second thermal interface material between the heat transfer element and the outer electrical conductor, wherein the step of applying the second thermal interface material is performed after disposing the heat transfer element within the opening.

In an embodiment, the second thermal interface material is the same as the first thermal interface material.

According to a fourth aspect, the invention provides a method for cooling the inner electrical conductor of the electrical interconnect according to the first aspect of the invention, or any embodiment thereof, via outer electrical conductor and/or the heat transfer element,
wherein the method comprises the step providing a heatsink or a cooling medium in thermal contact with the outer electrical conductor and/or the heat transfer element.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIG. 1 schematically shows a cross-section of a first example of an electrical interconnect according to the invention;

FIGS. 2A and 2B schematically show examples of a cooling system comprising the electrical interconnect of FIG. 1 and a heat sink of a cryocooler;

FIG. 3 schematically shows a cross-section of a second example of an electrical interconnect according to the invention;

FIG. 4 schematically shows longitudinal cross-section of a third example of an electrical interconnect comprising two or more heat transfer elements, which are arranged spaced apart in a direction along a longitudinal axis of the electrical interconnect; and

FIG. 5 schematically shows transverse cross-section of a fourth example of an electrical interconnect comprising two heat transfer elements, which are arranged in a transverse plane substantially perpendicular to a longitudinal direction of the electrical interconnect;

### DETAILED DESCRIPTION OF THE INVENTION

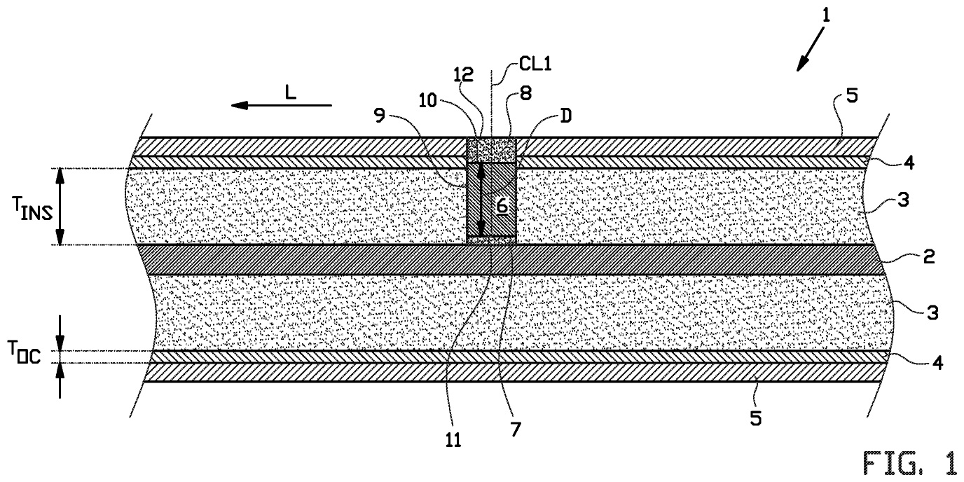

FIG. 1 schematically shows a cross-section of a segment of an electrical interconnect 1 in the form of a coaxial cable 1. The coaxial cable 1 comprises an inner electrical conductor 2 that extends along a longitudinal direction L of the coaxial cable 1. The coaxial cable 1 further comprises an electrically insulating layer 3, wherein the electrically insulating layer 3 is concentric with, and substantially surrounds the inner electrical conductor 2. Furthermore, the electrically insulating layer 3 extends along the longitudinal direction L of the coaxial cable 1. The electrically insulating layer 3 extends radially outwards from the inner electrical conductor 2. The electrically insulating layer 3 preferably comprises a dielectric material and has a thickness T_{INS}.

The coaxial cable 1 further comprises an outer electrical conductor 4, wherein n the outer electrical conductor 4 is concentric with both the inner electrical conductor 2 and the electrically insulating layer 3, wherein the outer electrical conductor 4 is shown surrounding the electrically insulating layer 3. The outer electrical conductor 4 has a thickness T_{OC}.

As schematically shown in FIG. 1, the outer electrical conductor 4 substantially coaxially surrounds the electrical insulating layer 3, wherein the electrical insulating layer 3 substantially fills the space between the inner electrical conductor 2 and the outer electrical conductor 4.

The coaxial cable 1 is further shown to comprise an outer sheath 5 of an electrically insulating material, which surrounds the outer electrical conductor 4. The outer sheath 5 forms an outer surface of the coaxial cable 1, insulating the coaxial cable 1 from the external environment.

The inner electrical conductor 2 is preferably made from copper, or an alloy thereof such as CuNi. Additionally, the inner conductor is electrical 2 preferably silver plated. The electrically insulating layer 3, located between the inner electrical conductor 2 and the outer electrical conductor 4, is preferentially made from a polymer such as polytetrafluoroethylene (PFPE). The outer electrical conductor 4, like the inner electrical conductor 2, is preferably made from copper, or an alloy thereof such as CuNi. Alternatively, the outer electrical conductor 4 may be manufactured from a stainless steel.

The dimensions of the cable, such as the thickness TINS of the electrical insulating layer 3 and the thickness Toc of the outer electrical conductor 4, and the materials used are selected to give a precise, constant conductor spacing so that the coaxial cable 1 can function efficiently as a transmission line.

As shown in FIG. 1, the coaxial cable 1 further comprises an opening 9, extending from the outer sheath 5 through the outer electrical and conductor 4 the electrically insulating layer 3 towards the inner electrical conductor 2. Preferably, the opening 9 extends radially outwards from the inner electrical conductor 2, substantially perpendicular to the longitudinal direction L.

The coaxial cable 1 further comprises a heat transfer element 6, wherein the opening 9 is configured such that the heat transfer element 6 fits within the opening 9. The heat transfer element 6 further comprises a first end 10 and an opposing second end 11. The heat transfer element 6 is positioned within the opening 9, wherein the first end 10 is shown oriented away from the inner electrical conductor 2. The first end 10 is further shown to contact the outer electrical conductor 4, at a position approximately in the middle of the outer electrical conductor 4. The second end 11 is shown oriented towards the inner electrical conductor 2. The heat transfer element 6 is made from an electrically insulating material with a high thermal conductivity, preferably having a thermal conductivity much higher than the thermal conductivity of the electrically insulating layer 3, preferably having a thermal conductivity more than ten times higher than the thermal conductivity of the electrically insulating layer 3, at the working temperature of the electrical interconnect 1. The heat transfer element 6 is configured to form a thermally conductive bridge between the inner electrical conductor 2 and the outer electrical conductor 4, passing through the electrically insulating layer 3. The heat transfer element 6 is preferably fabricated from an aluminum oxide based material such as a sapphire material. Most preferably the sapphire material is a single crystal wherein an axis with the higher thermal conductivity is oriented along the perpendicular direction.

As schematically shown in FIG. 1, the heat transfer element 6 extends in first distance D perpendicular to the longitudinal direction L, extending radially outwards from the inner electrical conductor 2. A center line CL1 of the heat transfer element 6 is oriented substantially perpendicular to the longitudinal direction L. The first distance D is approximately equal to the thickness T_{INS} of the insulating layer 3.

The coaxial cable 1 further comprises a first thermal interface material 7 located between the heat transfer element 6 and the inner electrical conductor 2. The second end 11 of the heat transfer element 6 is contacting the first thermal interface material The coaxial cable 1 further a comprises second thermal interface material 8 substantially similar or equal to the first thermal interface material 7. The second thermal interface material 8 is contacting the first end 10 of the heat transfer element 6, wherein the second thermal interface material 8 is located between the heat transfer element 6 and the outer electrical conductor 4. In the example presented in FIG. 1, a volume of the second thermal interface material 10 has been added so that an outermost surface 12 of the second thermal interface material 10 is substantially flush with an outermost surface of the coaxial cable 1. The first and second thermal interface material 10, 11 are preferably a thermally conductive adhesive such as a silver-filled epoxy.

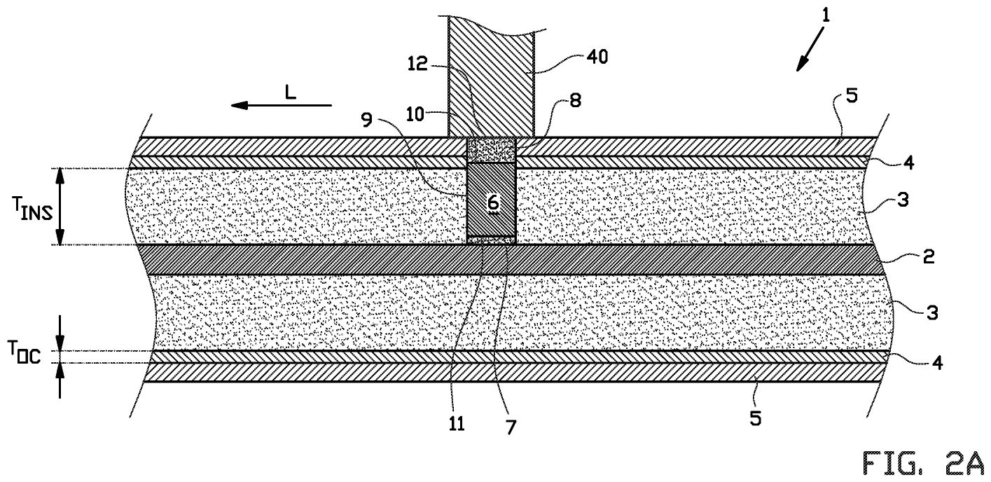

FIG. 2A schematically shows an example of a cooling system comprising the electrical interconnect 1 of FIG. 1 and a heat sink 40 of a cryocooler. As schematically shown, the heat sink 40 is arranged to abut the outer surface 12 of the second thermal interface material 8. Accordingly, the outer surface 12 of the second thermal interface provides a heat transfer surface, and both the inner electrical conductor 2 and the outer electrical conductor 4 can be cooled by the heat sink 40 which is arranged in thermal contact with said heat transfer surface, due to the thermal bridging mediated by the heat transfer element 6.

FIG. 2B schematically shows an alternative example of a cooling system comprising the electrical interconnect 1 of FIG. 1 and a heat sink 40 of a cryocooler. In this example, the heat sink 40 or cooling medium is provided in contact with the outer electrical conductor 4 at a position along the electrical interconnect 1 where the outer sheath 5 has been removed to provide a heat transfer surface 13. Preferably, and as schematically shown in FIG. 2B, this removal of the outer sheath 5 is arranged at or near the location of the heat transfer element 6. Accordingly, the heat sink 40 directly cools the electrical 4. outer conductor Due to the thermal conductivity of the outer electrical conductor 4 and the thermal bridging between the inner electrical conductor 2 and the outer electrical conductor 4, as mediated by the heat transfer element 6, the inner electrical conductor 2 is also cooled by the heat sink 40.

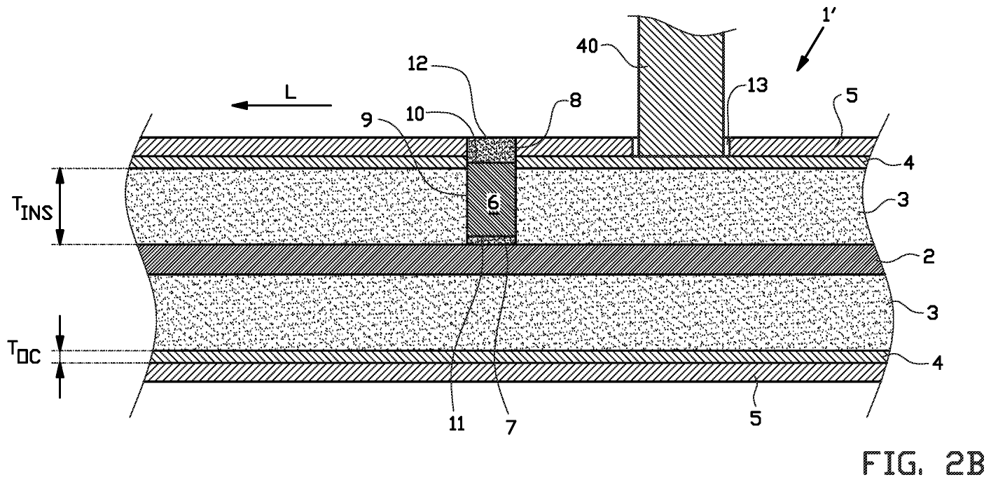

FIG. 3 illustrates a second example of an electrical interconnect 20 according to the invention. In this example, the electrical interconnect 20 is in the form of a coaxial connector 20. The FIG. 3 shows a schematic cross-section of coaxial connector 20 comprising an inner electrical conductor 21 that extends along a center line C12 of the coaxial connector 20. The coaxial connector 20 further comprises an electrically insulating layer 22, wherein the electrically insulating layer 22 is concentric with, and substantially surrounds the inner electrical conductor 21. The electrically insulating layer 22 has a thickness T_{INS}.

The coaxial connector 20 further comprises an outer electrical conductor 23, wherein the outer electrical conductor 23 is concentric with both the inner electrical conductor 21 and the electrically insulating layer 22, wherein the outer electrical conductor 23 is shown surrounding the electrically insulating layer 22.

The coaxial connector 20 of FIG. 3 further comprises an opening 27, extending from the outer electrical conductor 23, through the electrically insulating layer 22 towards the inner electrical conductor 21. The opening 27 in this example is a substantially circle-cylindrical opening which extends radially outwards from the inner electrical conductor 21.

The coaxial connector 20 further comprises a heat transfer element 24 with a circle-cylindrical shape, wherein the opening 27 is configured such that the heat transfer element 24 fits within the opening 27. The heat transfer element 24 further comprises a first end 25 and an opposing second end 26. The heat transfer element 24 is positioned within the opening 27, wherein the first end 25 is shown oriented away from the inner electrical conductor 21. The outer electrical conductor 23 is arranged to abut the circumference of the first end 25 of the heat transfer element 24 in order to provide a thermal contact between the outer electrical conductor 23 and the heat transfer element 24. The surface of the heat transfer element 24 at the first end 25 is arranged substantially flush with the outer surface of outer electrical conductor 23. The second end 26 is oriented towards and abutting the inner electrical conductor 21, wherein the second end 26 provides a thermal contact between the inner electrical conductor 21 and the heat transfer element 24.

The heat transfer element 24 is prepared from an electrically insulating material with a high thermal conductivity, preferably with a thermal conductivity which is at least ten times higher than the thermal conductivity of the electrically insulating layer 22, at the working temperature of the coaxial connector 20. The heat transfer element 24 is configured to form a thermally conductive bridge between the inner electrical conductor 21 and the outer electrical conductor 23, passing through the electrically insulating layer 22.

A center line CL3 of the cylindrically shaped heat transfer element 24 is shown oriented perpendicular to a center line CL2 of the coaxial connector 20. The heat transfer element 24 is shown extending a first distance D along the center line CL3, extending radially outwards from the inner electrical conductor 21. The first distance D is shown in the FIG. 3 to be approximately equal to a sum of the thickness T_{INS} of the insulating layer 22 and the thickness T_{OC} of the outer electrical conductor 23 at the position of the opening 27.

As schematically shown in FIG. 3, in the direction of the center line CL2 of the connector 20, the coaxial connector 20 comprises a male connector end 28 and an opposing female connector end 29. The male connector end 28 is configured for connecting with a female connector end of another electrical interconnect, while the female connector end 29 is configured for connecting with a male connector end of another electrical interconnect.

The male connector end 28 comprises a first cavity 31 configured to fit around an outer electrical conductor of another electrical interconnect. The male connector end 28 further comprises a pin 27, disposed within the first cavity 31, wherein the pin 27 is formed by the inner electrical conductor 21 extending along the center line CL2 of the coaxial connector 20.

The female connector end 29 is shown to comprise a second cavity 33 configured for accepting an insulating layer of another electrical interconnect. The female connector further comprises a third cavity 32 configured for accepting and making electrical contact with an inner electrical conductor of another electrical interconnect.

The coaxial connector 20 is configured such that the inner electrical conductor 21 can be cooled, via the heat transfer element 24, by providing a heat sink or a cooling medium to the outer electrical conductor 23 and/or the first end 25 of the heat transfer element 24 of the coaxial connector 20. In order to enhance the transfer of heat from the inner electrical conductor, a thin layer of a thermal interface material may be provided between the second end 26 of the heat transfer element 24 and the inner electrical conductor 21, and/or a thin layer of a thermal interface material may be provided between the circumference of the first end 25 of the heat transfer element 24 and the outer electrical conductor 23.

Preferably, the heat transfer element 24 comprises a Sapphire, Diamond or Silicon material which are substantially electrically insulating material with a relatively high thermal conductivity. The heat transfer element 24 thus provides a bridge between the inner electrical conductor 21 and the outer electrical conductor 23. Preferably, the second end 26 of the heat transfer element 24 is glued against the inner electrical conductor 26, using a silver filled epoxy, and the outer circumference of the first end 25 of the heat transfer element 24 is glued against the inner circumference of the opening in the outer electrical conductor 23, in order to enhance the thermal conduction between the inner electrical conductor 24 and the outer electrical conductor 23 via the heat transfer element 24.

In the example shown in FIG. 3, both the inner electrical conductor 21 and the outer electrical conductor 23 can be cooled by providing a heat sink 40 or a cooling medium such as liquid helium, in contact with the outer surface of the outer electrical conductor 23, which provides a heat transfer surface 34.

When cooling the coaxial connector 20 down to cryogenic temperatures using the heat sink 40, and measuring the temperature of the inner conductor via a small thermometer glued to the inner conductor, revealed that the inner conductor could be cooled to about 120 mK with a standard connector without the heat transfer element 24 and to approximately 15 mK with a Sapphire heat transfer element according to the present invention.

In addition, since the heat transfer element 24 is an electrical insulator and has relatively small dimensions, no effect on the RF propagation has been detected.

While the coaxial connector as shown in FIG. 3 is formed as a SMA-type connector, it is noted that the coaxial connector alternatively may be formed as for example a SMP, MCX or MMCX-type coaxial connector.

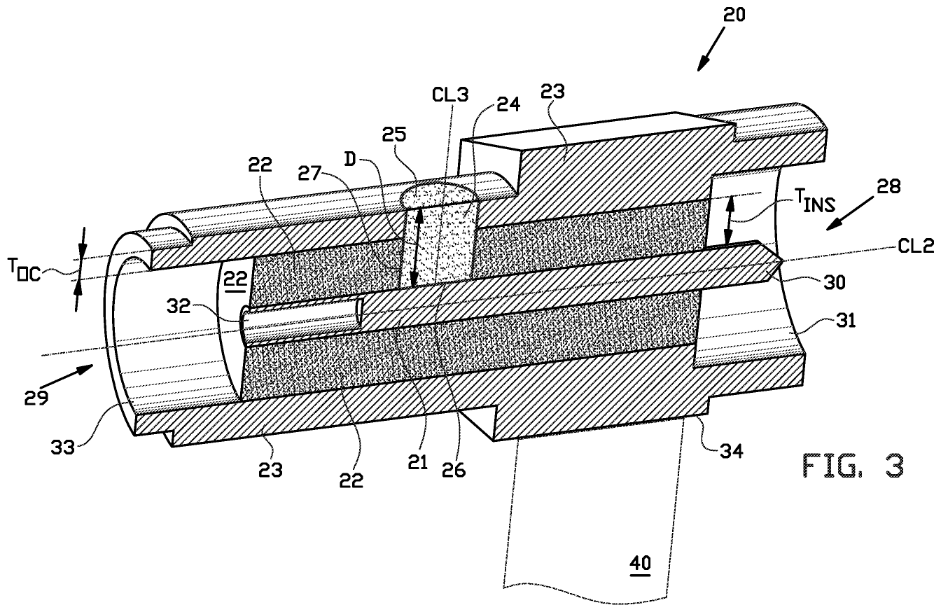

FIG. 4 schematically shows longitudinal cross-section of a third example of an electrical interconnect 40 comprising two or more heat transfer elements 46a, 46b, which are arranged spaced apart over a distance 41 in a longitudinal direction of the electrical interconnect 40. The electrical interconnect 40 is configured to provide a coaxial cable comprising an inner electrical conductor 42, an electrically insulating layer 43 that surrounds the inner conductor 42, an outer electrical conductor 44 that surrounds the electrically insulating layer 43 and is arranged coaxial with the inner electrical conductor 42. For this example, the same materials may be used as described above with reference to the example of FIG. 1, but other suitable materials are also possible. As schematically shown in FIG. 4, the electrical interconnect 40 comprises at least two heat transfer elements 46a, 46b, each of which is glued to the inner electrical conductor 42 using heat conducting glue 47 (for example silver filled epoxy glue) and to the outer electrical conductor 44 using heat conducting glue 48 (for example silver filled epoxy glue). By arranging two or more heat transfer elements 46a, 46b in parallel along the longitudinal axis of the electrical interconnect 40, also longer electrical interconnecting cables can be effectively cooled.

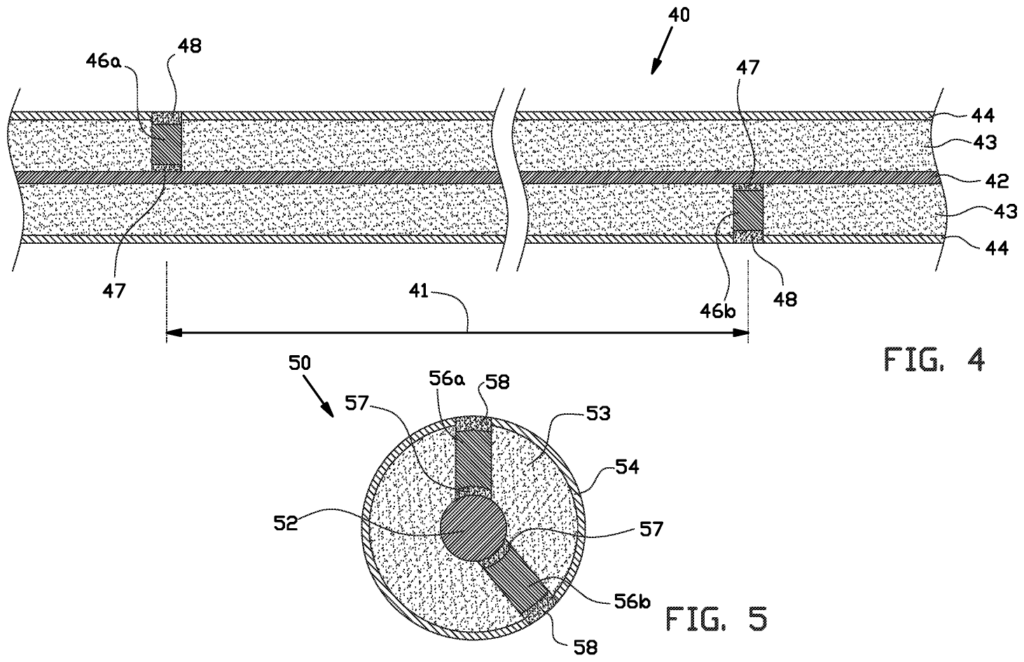

FIG. 5 schematically shows transverse cross-section of a fourth example of an electrical interconnect 50 comprising two heat transfer elements 56a, 56b, which are arranged in a transverse plane substantially perpendicular to a longitudinal direction of the electrical interconnect 50. The electrical interconnect 50 is configured to provide a coaxial cable comprising an inner electrical conductor 52, an electrically insulating layer 53 that surrounds the inner conductor 52, an outer electrical conductor 54 that surrounds the electrically insulating layer 53 and is arranged coaxial with the inner electrical conductor 52. For this example, the same materials may be used as described above with reference to the example of FIG. 1, but other suitable materials are also possible. As schematically shown in FIG. 5, the electrical interconnect 50 comprises two heat transfer elements 56a, 56b, each of which is glued to the inner electrical conductor 52 using heat conducting glue 67 (for example silver filled epoxy glue) and to the outer electrical conductor 54 using heat conducting glue 58 (for example silver filled epoxy glue). By arranging two heat transfer elements 56a, 56b in parallel along the circumference of the electrical interconnect 50, the heat transfer between the inner electrical conductor 52 and the outer electrical conductor 54 can be enhanced.

It is noted that in a further example, the electrical interconnect of the present invention comprises two or more heat transfer elements, which are arranged spaced apart in a direction along a longitudinal axis of the electrical interconnect and two or more heat transfer elements which are arranged in a transverse plane substantially perpendicular to a longitudinal direction of the electrical interconnect, thus providing a combination of the third and fourth example shown in FIGS. 4 and 5 and described above.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1-23. (canceled)

24. An electrical interconnect for use at cryogenic temperatures, wherein the electrical interconnect comprises:
an inner electrical conductor,
an electrically insulating layer that substantially surrounds the inner electrical conductor,
an outer electrical conductor substantially co-axial with the inner electrical conductor, and
a heat transfer element, wherein the heat transfer element comprises an electrically insulating material, wherein the heat transfer element comprises a thermal conductivity which is larger than a thermal conductivity of the electrically insulating layer,
wherein the heat transfer element is arranged in an opening in the insulating layer and is configured for thermally connecting the inner electrical conductor with the outer electrical conductor,
wherein the electrical interconnect further comprises a thermal interface material, wherein the thermal interface material is located between the heat transfer element and the inner electrical conductor.

25. The electrical interconnect according to claim 24, wherein the heat transfer element has a cylindrical shape, preferably a circle-cylindrical shape.

26. The electrical interconnect according to claim 25, wherein a center line of the cylindrically shaped heat transfer element is oriented substantially perpendicularly to a longitudinal axis of the inner electrical conductor.

27. The electrical interconnect according to claim 24, wherein the thermal interface material is also located between the heat transfer element and the outer electrical conductor.

28. The electrical interconnect according to claim 24,
wherein the thermal interface material is a thermally conductive adhesive, or
wherein the thermal interface material is a metal-filled epoxy, or
wherein the thermal interface material is a silver-filled epoxy.

29. The electrical interconnect according to claim 28, wherein the thermal interface material is a metal-filled epoxy, wherein the amount of metal/silver in said metal-filled epoxy is larger than 70%.

30. The electrical interconnect according to claim 24, wherein the heat transfer clement extends a first distance along a perpendicular direction, wherein said perpendicular direction is substantially perpendicular to a longitudinal axis of the inner electrical conductor. wherein the first distance is greater than or substantially equal to a thickness of the insulating layer.

31. The electrical interconnect according to claim 30, wherein the first distance is smaller than or substantially equal to a sum of the thickness of the insulating layer and a thickness of the outer electrical conductor.

32. The electrical interconnect according to claim 24, wherein the heat transfer element is fabricated from an aluminum oxide based material.

33. The electrical interconnect according to claim 32, wherein the heat transfer clement is fabricated from a single crystal sapphire material.

34. The electrical interconnect according to claim 24, wherein the outer electrical conductor comprises CuNi or stainless steel, and/or wherein the inner electrical conductor comprises CuNi or silver plated CuNi, and/or wherein the isolating layer comprises polytetrafluoroethylene (PFTE).

35. The electrical interconnect according to claim 24, wherein the electrical interconnect comprises a heat transfer surface, wherein said heat transfer surface comprises a part of the outer electrical conductor, the heat transfer element and/or the thermal interface material. wherein said heat transfer surface is configured to be thermally connectable with a heatsink or a cooling medium.

36. The electrical interconnect according to claim 24, wherein the electrical interconnect is a coax cable, or a SMA, SMP, MCX or MMCX type connector.

37. The electrical interconnect according to claim 24, wherein the electrical interconnect comprises two or more heat transfer elements.

38. The electrical interconnect according to claim 37, wherein the two or more heat transfer elements are arranged along a circumference of the electrical interconnect, and/or wherein the two or more heat transfer elements are arranged spaced apart in a direction along a longitudinal axis of the electrical interconnect.

39. A cooling system for cooling an electrical interconnect, wherein the cooling system comprises an electrical interconnect according to claim 24, and a cryocooler,
wherein the cryocooler comprises a heatsink, wherein the cryocooler is configured for actively cooling said heatsink.
wherein the heatsink is configured to be placed in thermal contact with the outer electrical conductor of the electrical interconnect.

40. A method for manufacturing an electrical interconnect according to claim 24. wherein the method comprises the steps of:
providing an electrical interconnect which comprises an inner electrical conductor. an electrically insulating layer that substantially surrounds the inner electrical conductor, an outer electrical conductor substantially co-axial with the inner electrical conductor, and an opening. wherein the opening extends through the insulating layer, and wherein the opening extends from the outer electrical conductor to at least the inner electrical conductor,
disposing a heat transfer element in the opening and thermally connecting the heat transfer element with the inner electrical conductor and with the outer electrical conductor in order to thermally bridge the outer electrical conductor with the inner electrical conductor of the electrical interconnect, wherein the heat transfer element comprises an electrically insulating material, wherein the heat transfer element comprises a thermal conductivity which is larger than a thermal conductivity of the electrically insulating layer.

41. The method according to claim 40, wherein the method further comprises the step of:
applying a first thermal interface material between the inner electrical conductor and the heat transfer element, wherein the step of applying a first thermal interface material is performed before the step of disposing the heat transfer element within the opening.
wherein the first thermal interface material is a thermally conductive adhesive, or
wherein the first thermal interface material is a metal-filled epoxy, or
wherein first thermal interface material is a silver-filled epoxy.

42. The method according to claim 40, wherein the method further comprises the step of:
applying a second thermal interface material between the heat transfer element and the outer electrical conductor, wherein the step of applying the second thermal interface material is performed after disposing the heat transfer element within the opening,
wherein the first thermal interface material is a thermally conductive adhesive, or
wherein the first thermal interface material is a metal-filled epoxy, or
wherein first thermal interface material is a silver-filled epoxy.

43. A method for cooling the inner electrical conductor of the electrical interconnect according to claim 24 via the outer electrical conductor and/or the heat transfer element,
wherein the method comprises the step of providing a heatsink or a cooling medium in thermal contact with the outer electrical conductor and/or the heat transfer element.
